(19) United States
(12) Patent Application Publication
(10) Pub. No.: US 2009/0205236 A1
(43) Pub. Date: Aug. 20, 2009

(54) Protective display frame

(76) Inventor: Nancy Jordan, Los Altos, CA (US)

Correspondence Address: Nancy Jordan, 315 Alta Vista Ave, Los Altos, CA, 94022, US

(21) Appl. No.: 12/032,625

(22) Filed: Feb. 15, 2008

(51) Int. Cl. A01G 1/06

(52) U.S. Cl. 40/737; 40/765

(57) ABSTRACT

A display frame for stacking or handling by children comprising of a shatter-resistant cover of transparent material, having a face and at least one side; a backing member of pliable material with at least one face comprising at least one groove dimensioned to fit the side(s) of the shatter-resistant cover. The display object is placed on the face of the backing member and the shatter-resistant cover is pushed onto the backing member with the groove of the backing member encasing the side(s) of the shatter-resistant cover. A method for framing is also included.

### FIELD OF INVENTION

This invention relates to display frames for displaying objects such as photographs, illustrations, pictures and three-dimensional items, particularly frames that protect the display object so the frame can be handled by children, stacked on other frames, or be used in environments where moisture is a problem.

### BACKGROUND OF INVENTION

With personal computers, digital cameras, and printers, it has never been easier to create photographs and artwork. People want more ways to display these pictures and personalize their environment. One way to display more pictures is on blocks of foam or similar material which can be stacked on top of one another. Pictures can be used to personalize children's blocks or be part of stacked frames that tell a story or illustrate an event.

Creating protective frames for children's use, stacking, or for wet environments have similar requirements. These requirements are that the frame be; protecting against liquids and moisture (such as water, steam, juice, and saliva), lightweight, shatter-resistant, easy to exchange the display object, and easy to move around. And of course keeping the cost reasonable is another important factor of a protective display frame.

Most conventional frames do not provide protection to the display object from moisture or liquid. Picture frames made of wood, metal, or glass are not suitable for stacking, a wet environment, or children's use since they are not lightweight and can easily be damaged. And many plastic frames do not provide protection from moisture or liquid. Frames that do provide protection from moisture or liquid can be improved to create a protective frame that is better suited for displaying pictures or other objects for stacking, children's use, or use in a wet environment.

The ability to easily exchange the display object is an important feature of a protective frame. People have a lot of pictures that they want to display and want to be able to change them frequently. Some waterproof frames require the picture to be laminated or permanently sealed into the framing structure, thus making changing the picture difficult without damaging the picture or frame.

Other waterproof frames have additional parts that make manufacturing more expensive. U.S. Pat. Nos. 5,125,175 and 5,307,574 describe a waterproof, safety frame for children with a sealing sheet in addition to the front and back subframes and a transparent viewing frame. Some waterproof frames require additional elements like hinges and sealing ribs to keep the picture free from moisture or water. A moisture-resistant, protective display frame can be designed with fewer parts that allow the display object to be exchanged easily and the frame to be stacked or played with.

U.S. Pat. Nos. 5,581,925 and 5,787,627 describe a soft, pliable picture frame and method of framing that includes a frame formed of a unitary piece of soft, pliable foam material. This frame includes two openings, a front and back, to insert the photo, picture covering, and backing member sheet. A protective picture frame can be made with fewer parts. The display frame can also be designed to allow several frames to be stacked on top of one another.

Current photo blocks don't have a way to personalize and easily exchange the pictures while at the same time providing a design that can handle stacking and the handling of children without damaging the block or picture.

### OBJECTS AND SUMMARY OF INVENTION

The object of this invention is to provide a protective display frame that can be stacked and handled by children, such as picture blocks.

It is also an objective of this invention to provide a protective display frame that protects the displayed object inside (e.g. photograph, illustration, three-dimensional object) from outside elements such as moisture and liquids.

Additionally, the frame allows a user to change the displayed element by removing a first object from the frame and inserting a second object in the frame.

The frame is lightweight and shatter-resistant.

When the frame is attached to a surface, it can be moved easily in order to reposition it, clean behind it, or replace the displayed object inside.

When the frame is not attached to a surface, it can be stacked on top of other frames.

### BRIEF DESCRIPTION OF THE DRAWINGS

FIGS. 1-2 illustrate a framed picture according to the first embodiment of the present invention, where the picture cover has a face and sides and the backing member has a groove on face whereby sides of picture cover are pushed into this groove so the back face of the picture cover is against the face of the backing member with a display object in between.

FIG. 2 illustrates an exploded perspective front view of a framed picture from FIG. 1.

FIG. 3 illustrates a front view of the picture cover.

FIG. 4 illustrates a rear view of the picture cover.

FIG. 5 illustrates a close-up of the picture cover.

FIG. 6. illustrates a front view of the backing member with a groove in the front face dimensioned to fit the sides of the picture cover.

FIG. 7. illustrates a cross section of a framed picture as viewed along line 100 in FIG. 2.

FIG. 8. illustrates a cross section of a framed picture where the picture cover is flush with the front face of the backing member.

FIG. 8a illustrates an exploded perspective front view of a framed picture with picture cover that has two sides and backing member has groove dimensioned to fit sides of picture cover.

FIG. 9 illustrates an exploded perspective front view of a framed picture with optional holes that vent air as picture cover is pushed onto backing member.

FIG. 9a illustrates a rear view of a framed picture where both the front and back face of the backing member have a picture and picture cover assembly.

FIG. 9 b illustrates a rear view of a framed picture where that back face has optional suction cups as a means to attach to a surface.

FIG. 10 illustrates an exploded perspective view of a framed picture, where the backing member has an optional removable cutout that enables the picture cover to be removed.

FIG. 11 illustrates a cross section of a framed picture as viewed along line 300 in FIG. 10.

FIG. 12 illustrates a backing member that has an optional cutout of predetermined size and shape to accommodate a three dimensional display object.

FIG. 13 illustrates a framed picture according to the second embodiment of the present invention, whereby the backing member has more than one face with groove to fit sides of picture cover whereby to display a picture or display object on each face.

FIGS. 14 and 15 illustrates a framed picture that is circular in shape with suction cups to attach to surface.

### DETAILED DESCRIPTION

The present invention is described here with reference to the figures. However, this invention may be embodied in many different forms and should not be construed as limited to the embodiments described herein. The embodiments described here are provided so that someone skilled in the art will understand this invention. Like numbers refer to like elements throughout.

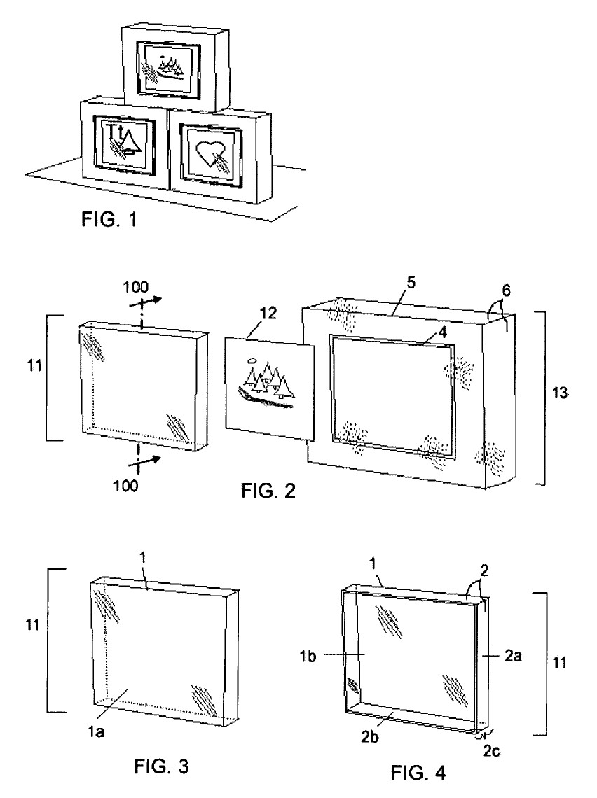

FIGS. 1-4 illustrate one embodiment of a framed picture according to the present invention as a protective display frame that can be stacked on top of each other. In this manner, it is used as a stacking frame or block. The framed picture comprises a transparent picture cover 11 formed of a unitary, lightweight, shatter-resistant material such as acrylic. The shatter-resistant material has a predetermined toughness and resilience so that if the frame falls, it will not break into many pieces. The picture cover has a face 1 with an outside-face 1a and an inside-face 1b, and at least one side 2 along the perimeter of the face 1 that is of predetermined depth 2c. The sides 2 of the picture cover 11 also have an outside-face 2a and an inside-face 2b. The sides 2 of the picture cover 11 have a predetermined shape, size, thickness, angle, and length. A backing member 13 constructed of a unitary, pliable, water-resistant material, has a front-face 5, sides 6, and a groove 4 that is dimensioned to fit snugly with the sides 2 of the picture cover 11. A picture 12 is placed on the front-face 5 of the backing member 13, inside the perimeter of the groove 4 of the backing member 13. The sides 2 of the picture cover 11 are aligned with the groove 4 of the backing member 13. The picture cover 11 is pushed onto the backing member 13 and picture 12 assembly so that the sides 2 of the picture cover 11 fit snugly into the groove 4 of the backing member 13 and provide a means for creating a barrier to help prevent moisture and liquids from reaching the picture 12. The picture 12 is sandwiched between the front-face 5 of the backing member 13 and the inside-face 1b of the face 1 of the picture cover 11. The picture 12 can be viewed through the picture cover 11. The picture cover 11 and backing member 13 are constructed of a predetermined size, shape, and thickness. The backing member 13 can be constructed of material such as foam with predetermined density and flexibility. The backing member 13 can also be constructed of other flexible materials such as plastic, rubber, or polysiloxanes.

FIG. 5 illustrates the picture cover 11 can be of a predetermined thickness 3.

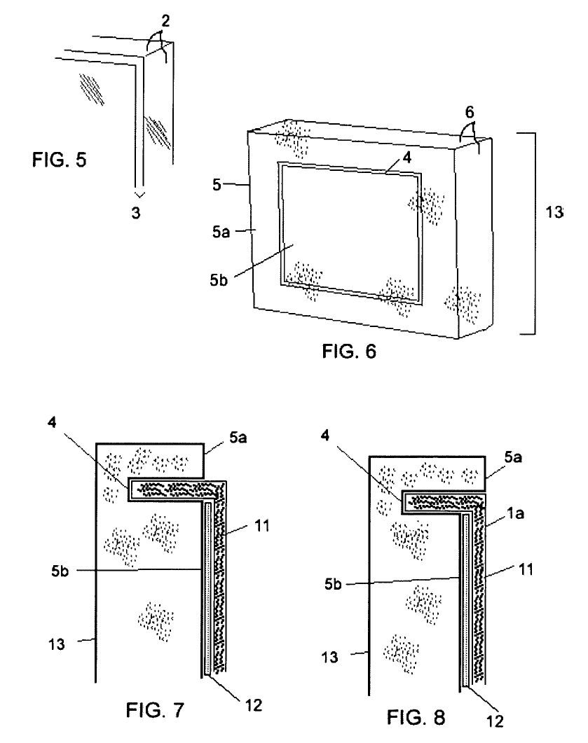

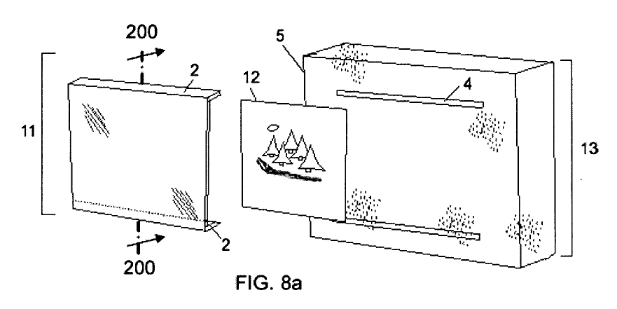

FIGS. 6-8 illustrate the backing member 13 comprises a front-face outside 5a the perimeter of the groove 4 and a front-face inside 5b the perimeter of the groove 4. In FIG. 8, the front-face inside 5b the perimeter of the groove 4 is dimensioned to allow the outside-face 1a of the picture cover 11 to be flush with the front-face outside 5a the perimeter of the groove 4.

FIG. 8a illustrates the framed picture with a picture cover 11 comprising two sides 2 and backing member 13 comprising grooves 4 dimensioned to fit sides 2 of picture cover 11.

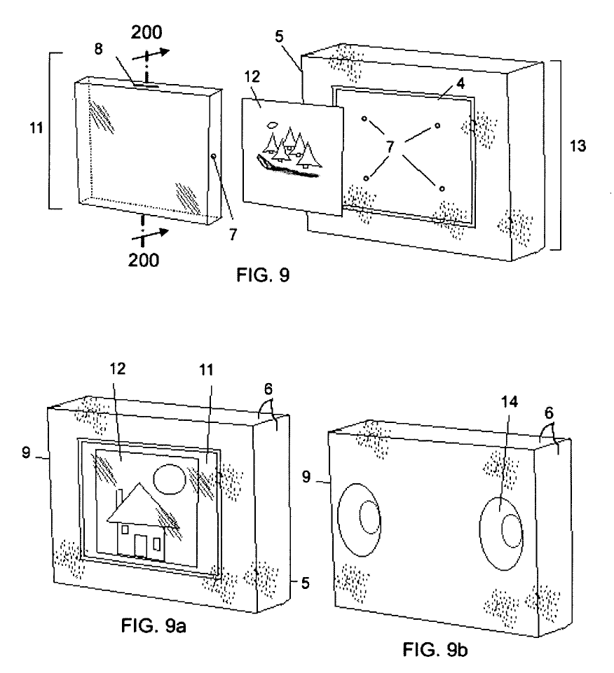

FIG. 9 illustrates the framed picture with optional holes 7 as a means to vent air as the picture cover 11 is pushed onto the backing member 13. The picture cover can also have a means to aid in removal of the picture cover 11 from the backing member 13, such as a ridge 8 or an indentation in the picture cover.

FIGS. 9a-9b illustrate the rear view of the framed picture. FIG. 9a illustrates the back face 9 of the backing member 13 having another picture 12 and picture cover 11 assembly so the picture frame holds two pictures. FIG. 9b illustrates the back face 9 of the backing member 13 having suction cups 14 as a means to attach to a surface. The means of attachment enable the framed picture to be hung at any angle, vertical or horizontal. Other means of attachment include hooks, adhesives, tapes, and the like.

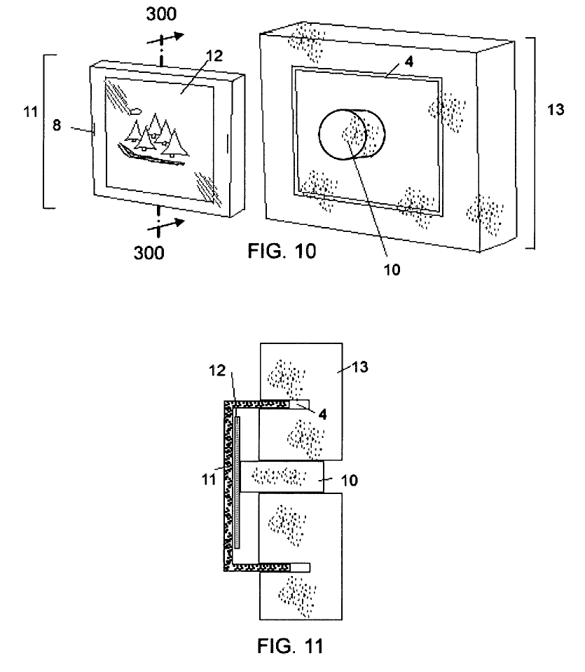

FIG. 10-11 illustrates the backing member 13 can have a means of removing the picture cover 11 from the backing member. An optional removable cutout 10, of a predetermined size and shape, can be pushed as in FIG. 11 to help remove the picture cover 11 and picture 12 assembly off of the backing member 13 in order to exchange the picture 12.

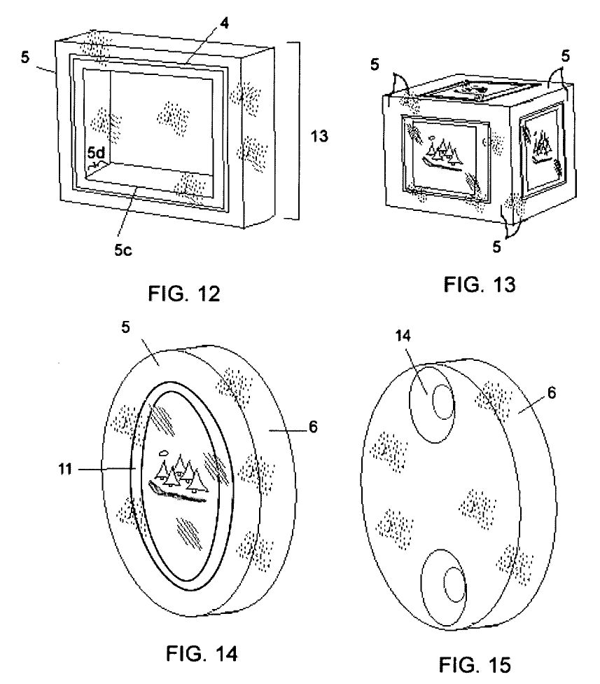

FIG. 12 illustrates the backing member 13 can have at least one cutout 5c in the front-face 5, of a predetermined size, shape, and depth 5d, to accommodate a three-dimensional display object.

FIG. 13 illustrates a second embodiment of a framed picture where the frame is used as a block with a picture 12 and picture cover 11 assembly on at least one of the sides of the block. In this embodiment, the backing member 13 is in the shape of a block, rectangle, or other stackable shape of predetermined size, with sides of predetermined size. The backing member 13 can have a picture 12 and picture cover 11 assembly on all sides of the block, rectangle, or other stackable shape.

FIGS. 14-15 illustrate the framed picture in circular shape with suctions cups 14 as a means of attachment to a surface.

While the best modes for carrying out the invention have been described here, those familiar with the art to which this invention relates, will recognize various alternative designs and embodiments for practicing the invention as defined by the following claims.

I claim:

1. A display frame that protects the frame and picture, comprising:
a shatter-resistant cover of transparent material for viewing and protecting the display object, the shatter-resistant cover comprising a face, having a front-face and opposing back-face, and sides along the perimeter of the face that are perpendicular to the face with each one of the sides having a front-face and a back-face; and
a backing member of pliable material for supporting and protecting the display object, the backing member comprising at least one face with at least one groove that secures the sides of the shatter-resistant cover to the backing member when the display object is placed on the face of backing member, and the shatter-resistant cover is pushed onto the backing member with the groove of the backing member encasing the sides of the shatter-resistant cover.

2. The display frame of claim 1, wherein the shatter-resistant cover is composed of acrylic.

3. The display frame of claim 2, wherein a first one of the sides of the shatter-resistant cover has a lip of along the whole perimeter of the first side that is configured to secure the shatter-resistant cover to the backing member to provide a moisture barrier.

4. The display frame of claim 1, where in the shatter-resistant cover is of predetermined size, shape, and thickness.

5. The display frame of claim 1, wherein the sides of the shatter-resistant cover are of predetermined shape, size, thickness, length, and angle from the face of the cover.

6. The display frame of claim 1, wherein the backing member is composed of resilient material such as cross-linked polyolefin.

7. The display frame of claim 1, where in the backing member is of predetermined size, shape, and density.

8. The display frame of claim 1, wherein the backing member comprises at least one groove on at least one face of the backing member that is dimensioned to secure at least one of the sides of the shatter-resistant cover to the backing member.

9. The display frame of claim 1, wherein the backing member comprises at least one cutout that is configured to surround at least one three-dimensional object.

10. The display frame of claim 1, wherein the backing member comprises a removable cutout of predetermined size, shape, and placement configured to facilitate easy removal of the shatter-resistant cover.

11. The display frame of claim 1, wherein at least one side of the shatter-resistant cover comprises a means of removing the shatter-resistant cover from the backing member such as an indentation, ridge, and the like.

12. The display frame of claim 1, wherein at least one side of the shatter-resistant cover comprises a means of venting air as the picture and shatter-resistant cover assembly is pushed onto the backing member, such as at least one hole.

13. The display frame of claim 1, wherein the backing member comprises at least one groove on at least one face of the backing member that is dimensioned to couple to the lip of the shatter-resistant cover.

14. The display frame of claim 1, further comprising a means of attachment that is coupled to the backing member and configured to attach the display frame to a wall of a shower or bathtub enclosure.

15. A display frame for that protects the frame and picture, comprising:
a shatter-resistant cover of transparent material for viewing and protecting the display object, the shatter-resistant cover comprising a face, having a front-face and opposing back-face, and sides along part of the perimeter of the face that are perpendicular to the face with each one of the sides having a front-face and a back-face; and
a backing member of pliable material for supporting and protecting the display object, the backing member comprising at least one face with at least one groove that secures the sides of the shatter-resistant cover to the backing member when the display object is placed on the face of backing member, and the shatter-resistant cover is pushed onto the backing member with the groove of the backing member encasing the sides of the shatter-resistant cover.

16. The display frame of claim 15, wherein the backing member comprises at least one cutout that is configured to surround at least one three-dimensional object.

17. The display frame of claim 15, wherein the backing member comprises at least one groove on at least one face of the backing member that is dimensioned to secure at least one of the sides of the shatter-resistant cover to the backing member.

18. The display frame of claim 15, where in the shatter-resistant cover is of predetermined size, shape, and thickness.

19. The display frame of claim 15, wherein the sides of the shatter-resistant cover are of predetermined shape, size, thickness, length, and angle from the face of the cover.

20. The display frame of claim 15, wherein the backing member is composed of resilient material such as cross-linked polyolefin.

21. The display frame of claim 15, where in the backing member is of predetermined size, shape, and density.

22. A method of framing a display object for protecting a frame from damage such as when knocked over, the method comprising:
providing shatter-resistant cover of transparent material for viewing and protecting the display object, the shatter-resistant cover comprising a face, having a front-face and opposing back-face, and sides along the perimeter of the face;
providing a backing member integrally formed of a unitary piece of pliable material with at least one face and at least one groove that is dimensioned to fit the sides of the shatter-resistant cover;
inserting a display object against the face of the backing member;
aligning the sides of the shatter-resistant cover with the groove of the backing member; and
pushing the shatter-resistant cover onto the backing member with the groove of the backing member encasing the sides of the shatter-resistant cover.
